(19) United States
(12) Patent Application Publication
(10) Pub. No.: US 2014/0001755 A1
(43) Pub. Date: Jan. 2, 2014

(54) COUPLING WITH LOCKING COLLAR FOR COUPLING TOGETHER TWO TUBULAR MEMBERS

(71) Applicant: Yasuo Ogami, Torrance, CA (US)

(72) Inventor: Yasuo Ogami, Torrance, CA (US)

(21) Appl. No.: 13/538,949

(22) Filed: Jun. 29, 2012

(51) Int. Cl. F16L 19/00; B23P 11/00; F16L 19/06

(52) U.S. Cl. 285/421; 285/420; 137/15.09

(57) ABSTRACT

A coupling for connecting one tubular member to another tubular member. The coupling includes a locking collar and coupling body with a ramp. In use, the locking collar is moved along the body until the tubular member is trapped between the locking collar and the ramp.

### FIELD OF THE INVENTION

The present invention relates to improvements in couplings for securing tubular members to one another of the same or different size.

### BACKGROUND OF THE INVENTION

Couplings are used in a wide variety of applications. In an agricultural setting, couplings are often used to facilitate connecting pipes and hoses. A problem arises when a hose has a diameter which is incompatible with the pipe or hose to which connection is desired. Accordingly, what is needed is a coupling which facilitates connection of hoses of the same or different size in a manner which reduces the risk of leakage.

### SUMMARY

The present invention in one preferred aspect provides for a coupling for connecting a hose to a pipe or a second hose, the coupling including a body having a first end, a second end, an exterior surface, an interior surface and a length from the first end to the second end. The interior surface forms a passage through the body from the first end to the second end, the passage having an entrance at the first end and an exit at the second end, the ends each having a maximum outer diameter. The exterior surface of the body has a middle portion between the ends, the middle portion having an outer diameter less than the maximum outer diameter of at least one of the ends. The coupling includes a locking collar having a unitary, non-adjustable body with an inner diameter and an outer diameter, the inner diameter being less than the maximum outer diameter of the at least one of the ends so that as the locking collar is moved along the length toward the at least one of the ends, the locking collar contacts a portion of the hose to trap the hose between the locking collar and the exterior surface of the body, permitting the hose to be clamped between the body and the locking collar during the flow of a liquid through the passage into the hose.

In a further preferred aspect, the present invention provides for a coupling for connecting a hose to a pipe or a second hose, the coupling including a body having a first end, a second end, an exterior surface, an interior surface and a length from the first end to the second end. The interior surface forms a passage through the body from the first end to the second end, the passage having an entrance at the first end and an exit at the second end. The exterior surface forms a ramp with an outer diameter that increases in a direction towards the exit, the ramp having a maximum outer diameter. The exterior surface of the body has a middle portion between the ends, the middle portion having an outer diameter less than the maximum outer diameter of ramp. The coupling includes a locking collar having an inner diameter and an outer diameter, the inner diameter being less than the maximum outer diameter of the ramp so that as the locking collar is moved along the length from the middle portion toward the exit, the locking collar contacts a portion of the hose to trap the hose between the locking collar and the ramp, permitting the hose to be clamped between the body and the locking collar during the flow of a liquid through the passage into the hose.

In another preferred aspect, the present invention provides a method for connecting a first tubular member to a second tubular member. The method includes connecting the first tubular member to a coupling having a first end, a second end, a length from the first end to the second end, and a passage from the first end to the second end, the first tubular member being connected to the first end; engaging the second tubular member to the second end; moving a locking collar along the length of the coupling until the locking collar traps the second tubular member at least in part between the locking collar and the coupling; and clamping the second tubular member at least in part between the coupling and the locking collar using a flow of a liquid through the passage into the second tubular member.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE FIGURES

FIG. 1 is an exploded perspective view of a coupling body with a locking collar for locking a hose to one end of the coupling body in accordance with a preferred embodiment of the present invention.

FIG. 2 is a side elevation view of the coupling body and locking collar of FIG. 1.

FIG. 3 front elevation view of the coupling body and locking collar of FIG. 1.

FIG. 4 is side elevation view of the coupling body of FIG. 1 prior to engagement with the hose of FIG. 1 in accordance with a preferred method of the present invention.

FIG. 5 is a side elevation view of the hose being moved over the coupling body of FIG. 4.

FIG. 6 is a side elevation view of the locking collar of FIG. 4 being moved to trap the hose between the locking collar and the body of the coupling, and the coupling body being engaged with a pipe.

FIG. 7 is a side elevation view of the coupling body of FIG. 4 with a plurality of engagement cams moveable to engage the coupling body to the pipe.

FIG. 8 is a partial cross sectional side view of the engagement cams of FIG. 7 being moved from an unengaged position to an engaged position with the pipe.

FIG. 9 is a partial cross sectional side view of the engagement cams of FIG. 7 in an engaged position with the pipe.

FIG. 10 is an expanded view of a cross section of the locking collar, hose and coupling body of FIG. 9 taken along line 10 of FIG. 9.

FIG. 11 is a perspective view of a coupling body with a pair of locking collars for locking a hose to each end of the coupling body in accordance with another preferred embodiment of the present invention.

### DETAILED DESCRIPTION OF THE DRAWINGS

Reference will now be made in detail to the present preferred embodiments of the invention, examples of which are illustrated in the accompanying drawings.

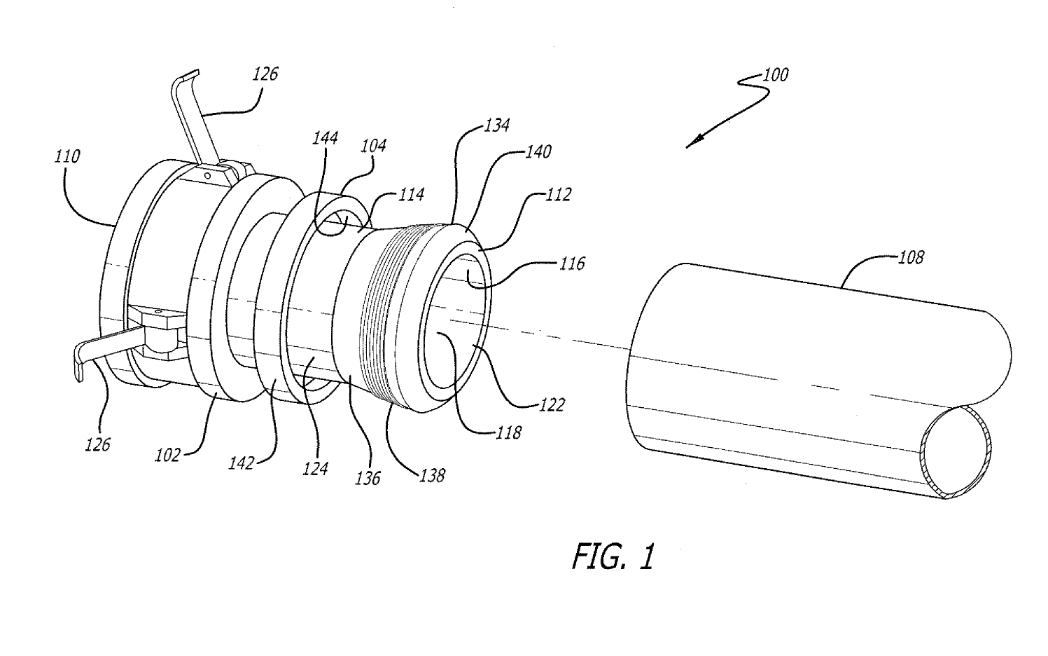

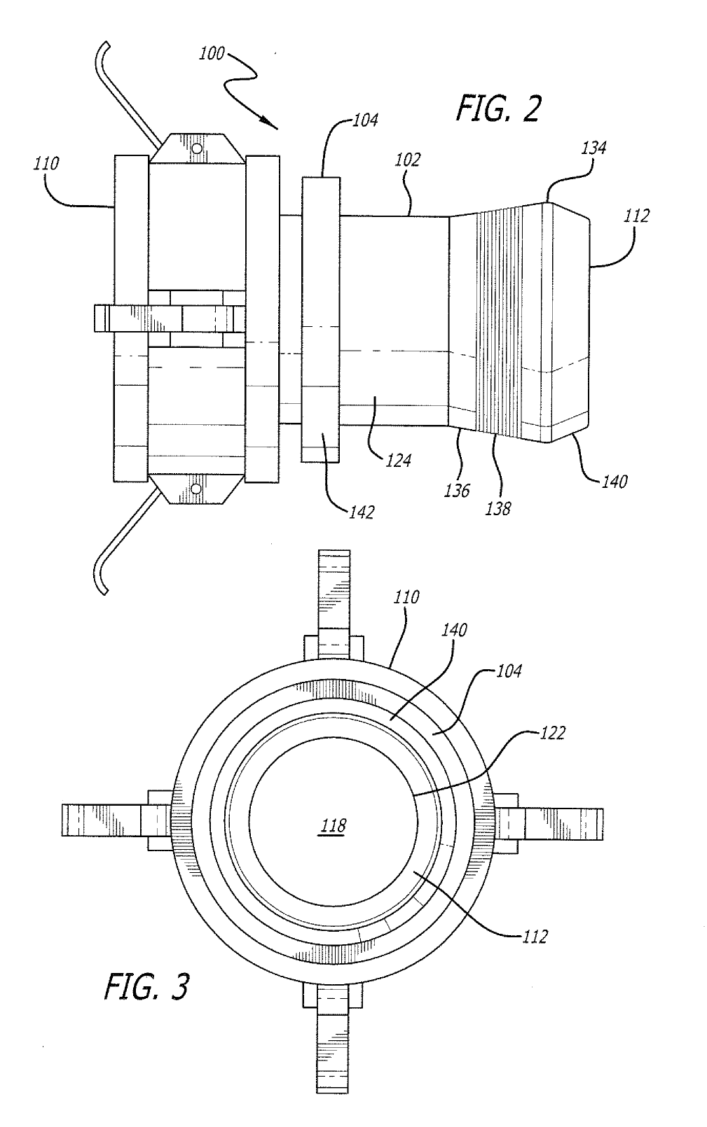

FIGS. 1 to 10 show a preferred embodiment of a coupling 100 having a coupling body 102 and a locking collar 104 for coupling a pipe 106 to a hose 108. In use, one end of body 102 is inserted into hose 108. Another end of body 102 is secured to pipe 106. Locking collar 104 is moved over hose 108 until further progress is impeded by a nipple at one end of body 102. Fluid flow through coupling 100 into hose 108 creates a pressure in hose 108 which acts to create a clamping force between locking collar 104 and body 102 to lock hose 108 to coupling 100. The preferred elements of the coupling and their interrelationship are described in further detail below.

Referring to FIGS. 1-3 and 10, body 102 includes a first end 110, a second end 112, an exterior surface 114, and an interior surface 116 that forms a passage 118. Body 102 includes an entrance 120 to passage 118 and an exit 122 from passage 118. Exterior surface 114 further includes a middle portion 124 between first end 110 and second end 112. The relative dimensions of middle portion 124, locking collar 104 and ends 110, 112 are described in further detail below.

As shown in FIGS. 1, 8 and 9, entrance 120 preferably includes a plurality of cam members 126 to lock pipe 106 to first end 110 of body 102. Each cam member preferably includes a cam 128 at one end and a free end 130 at another end. To facilitate interaction between cam members 126 and pipe 106, entrance 120 preferably includes a plurality of respective cam openings 132 sized and shaped to accommodate cam members 126.

FIGS. 1 to 3 show exit 122 preferably forming a nipple 134. As used herein, a “nipple” is an annular formation configured to be inserted into an opening of a tubular member to impede movement of the tubular member over the annular formation. Nipple 134 is preferably at least in part frustoconical and includes a ramp 136 with a plurality of annular projections or ridges 138. Ramp 136 preferably has an outer diameter that increases in a direction towards second end 112. It will be appreciated that other projections may be used to enhance a friction fit between the hose, the ramp, and locking collar 104 without departing from the scope of the present invention. Nipple 134 preferably includes a chamfer 140 at its distal-most portion to facilitate insertion of nipple 134 into an end of hose 108.

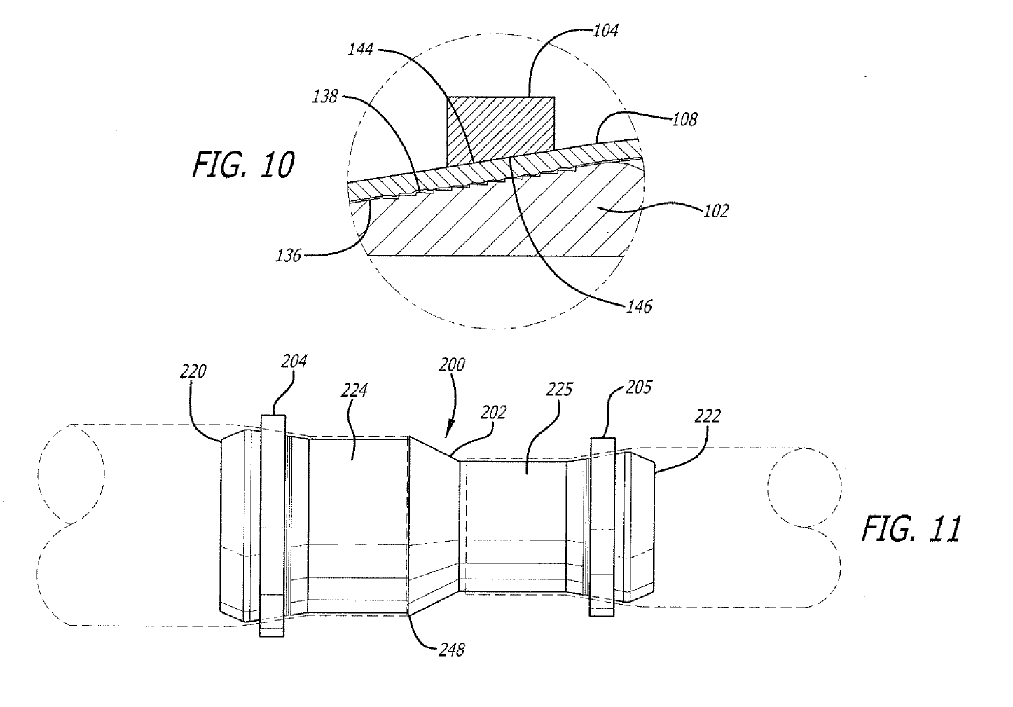

Referring to FIGS. 1, 2, 9 and 10, locking collar 104 preferably includes an exterior surface 142 and an interior surface 144. As shown in FIG. 10, interior surface 144 preferably includes a ramp 146 preferably having the same angle of inclination as ramp 136 of body 102. Ramp 146 is preferably smooth, but if desired, may include one or more projections, such as a plurality of annular ridges. Such annular ridges may be configured to correspond to annular ridges on ramp 136 of body 102. Interior surface 144 is preferably sized and configured to move along the exterior surface of body 102 until locking collar 104 engages nipple 134.

Preferred dimensions are set forth below, although it will be appreciated that the dimensions may be varied as suitable for the intended application. To facilitate engagement between locking collar 104 and nipple 134, locking collar 104 preferably has an inner diameter greater than the outer diameter of middle portion 124, but less than the maximum outer diameter of nipple 134. The inner diameter of locking collar may be slightly less than the maximum outer diameter of nipple 134 so that locking collar 104 may be disengaged from body 102 by an application of blunt force, for example, the use of a hammer. As shown in FIG. 2, the outer diameter of the locking collar is preferably greater than the maximum outer diameter of nipple 134, but less than the maximum outer diameter of first end 110 of body 102.

In a preferred embodiment, middle portion 124 preferably has an outer diameter of approximately 3.75 inches. The maximum outer diameter of the nipple is preferably approximately 4.25 inches. The maximum outer diameter of the entrance is preferably approximately 5.6 to 5.7 inches. The inner diameter of the passage is preferably approximately 3.1 to 3.2 inches at the exit and 4.75 inches at the entrance. Preferably, the passage has a uniform diameter along a majority of its length from the exit.

The locking collar preferably has an outer diameter of approximately 5 inches and an inner diameter of approximately 4.1 to 4.2 inches. It will be appreciated that these values are representative only and may be varied as appropriate.

Body 102 is preferably constructed from a sturdy plastic material, for example, an injection-molded thermoplastic such as polypropylene. Locking collar 104 is preferably made from a metal such as stainless steel, brass or aluminum. It will be appreciated that the body and locking collar may be constructed from a variety of materials without departing from the scope of the present invention. For example only, both the body and the locking collar may be formed of the same or different materials.

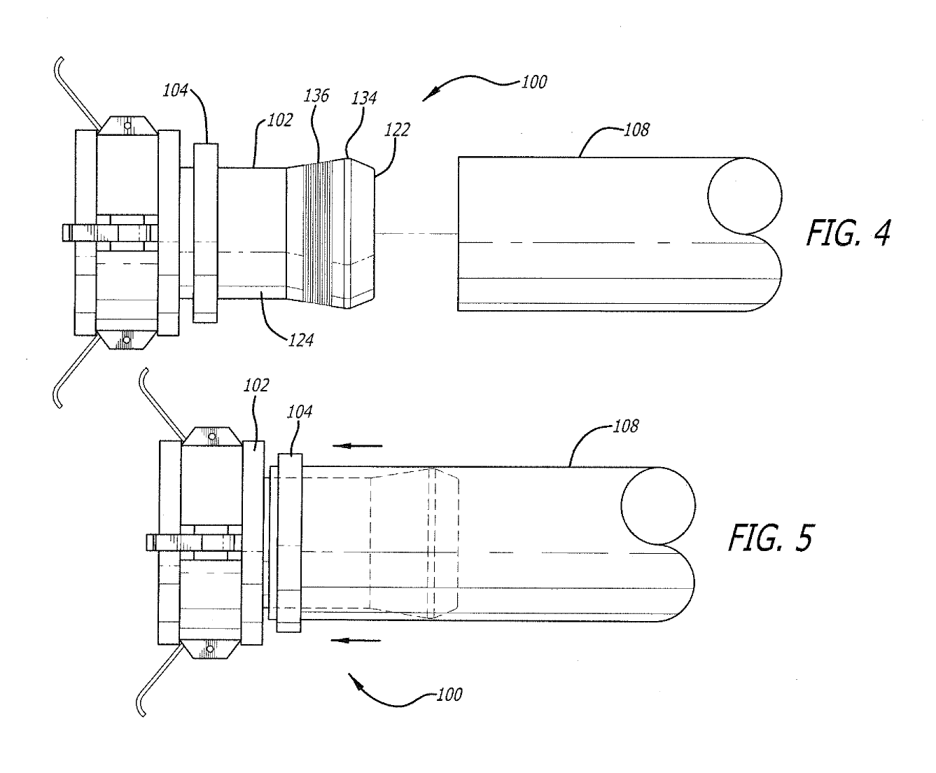

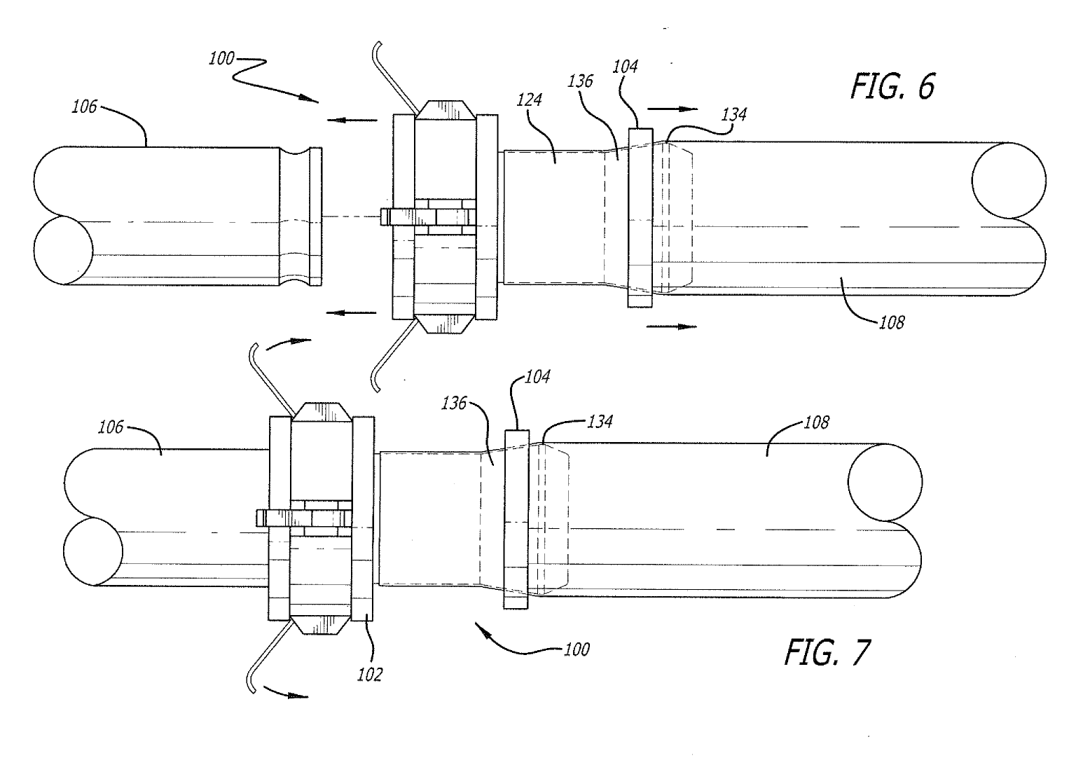

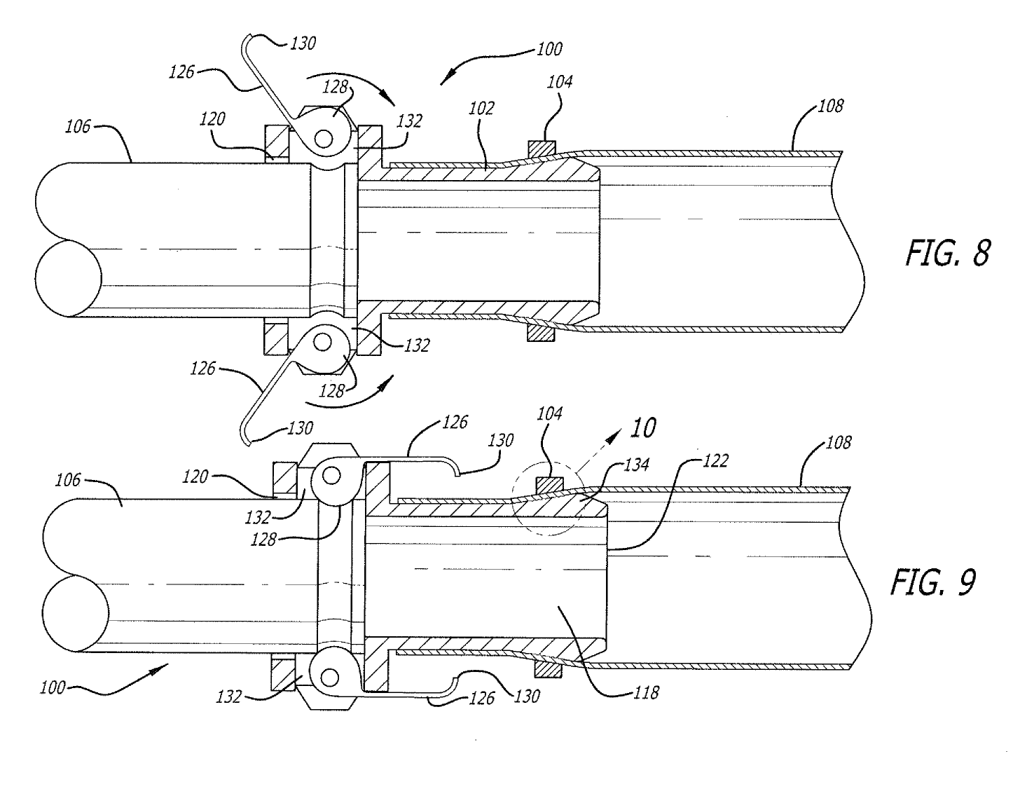

Having described the preferred components of the coupling, a preferred method of use will now be described with reference to FIGS. 4 to 10. Referring to FIGS. 4 and 5, a tubular member, such as hose 108, is engaged with exit 122 of body 102 by inserting nipple 134 into the end of the hose, and moving the hose between locking collar 104 and body 102. Locking collar 104 is moved from middle portion 124 along the central longitudinal axis of the coupling towards nipple 134 until further progress is impeded along ramp 136 as shown in FIGS. 6 and 7. Preferably, a user will use blunt force to snugly trap hose 108 between locking collar 104 and body 102. Ridges 138 assist to trap hose 108 by creating an enhanced friction fit with hose 108 as shown in FIG. 10. Referring to FIG. 8, a second tubular member, such as pipe 106, is connected to entrance 120 of body 102 with cam members 126 in an unengaged position. Once pipe 106 is inserted into the entrance, free ends 130 of cam members 126 are moved toward body 102 so that cams 128 engage and hold pipe 106 in place relative to body 102.

With locking collar 104 in a locked position, a user activates an upstream valve to release a flow of fluid, such as water. The transition from the smaller diameter of passage 118 of coupling 100 to a larger diameter of hose 108 creates a pressure differential which acts to clamp the end of hose 108 between locking collar 104 and nipple 134.

To remove the hose, the user stops the flow of fluid through the coupling. A blunt force is preferably applied to move locking collar 104 away from exit 122. For example, the user may tap the locking collar with a hammer. Once locking collar 104 has been dislodged from nipple 134, hose 108 is pulled away from exit 122.

It will be appreciated that the steps described above may be performed in a different order, varied, or some steps omitted entirely without departing from the scope of the present invention. For example only, a user may attach coupling 100 to pipe 106 prior to attaching hose 108.

Referring now to FIG. 11, a coupling 200 is shown in accordance with another preferred embodiment of the present invention for use as a hose connector. Coupling 200 is similar to coupling 100 except that both ends of coupling 200 preferably include a nipple and respective locking collars. As shown in FIG. 11, body 202 has a first end 220 with an opening, a second end 222 with an opening, and a passage from first end 220 to second end 222. Body 202 further preferably includes a first middle portion 224, a second middle portion 225, and a stop 248 separating middle portions 224, 225.

In use, two different tubular members, such as hoses of the same or different diameters, may be attached to respective ends 220, 222 until they contact stop 248. Locking collars 204, 205 are moved along their respective ramps until they trap their respective hoses. Thereafter, blunt force is preferably applied to snugly secure the hoses to coupling 200.

The foregoing description is by way of example only, and may be varied considerably without departing from the scope of the present invention. For example only, the coupling body may have an entrance configured as a male coupling and an exit configured as a female coupling. The passage may have a diameter larger than that of the hose to be connected to the exit. The passage may vary in diameter along its length, for example, vary from a larger diameter to a smaller diameter, or vice-versa. The body may have a circular cross-section or any other cross-section as desired.

The exterior of the body may be formed in a variety of ways. For example, instead of a ramp, one or both ends of the body may be configured in a T-shape to create a stop to engage with the locking collar. The surface projections along the ramp may be configured as a series of ridges, such as shown in FIG. 1, a series of steps, a plurality of ratchets, a dimpled surface, or a roughened surface. The projections may circumferentially surround the body, or may be placed at regular or irregular intervals. The projections along the ramp may be omitted if desired to create a smooth surface.

The locking collar may be configured for movement within the passage to lock a hose from within the body. For example, the passage may contain a transition from a larger to smaller diameter. A hose may be inserted through the smaller diameter portion. A locking collar may be moved along the central longitudinal axis of the passage and into the end of the hose to trap the hose against the constriction. To facilitate the locking of the hose internally, the locking collar may be configured as a partial funnel.

The locking collar may be configured in a variety of ways. Preferably the locking collar has a complete perimeter. Other configurations are possible. For example only, the locking collar may have a C-shape (have an incomplete circumferential perimeter). The locking collar may have a hinge so that the locking collar may be opened on one side and closed around the coupling body and a hose engaged therewith. The closeable locking collar may be locked into a closed position.

The locking collar may be circular around a majority of its circumference, and deviate at a portion to create a tab or other engagement area so that the collar is not completely circular. Alternatively, the locking collar may have two opposed inner surfaces, which may be curved, to engage the hose and/or body of the coupling.

The coupling body may be configured for connecting a first tubular member of a first diameter to a second tubular member of a different diameter, such as shown in FIGS. 1-10, or may be configured for connecting tubular members of the same diameter. The body may be separable. For example, the hose connector in FIG. 11 may be configured so that instead of having a stop located centrally along the length of the body, the body may be divisible and attachable to one another via a screw thread. The body may have three ends, for example, shaped in a T-shape configuration. The entrance of the body may be configured to lock to a tubular member using mechanisms other than cams. For example, the entrance may have an internal and/or external screw thread. The entrance may have a circumferential groove for engagement with a tubular member having a locking mechanism, for example, one or more cams.

The features described with respect to one embodiment may be applied to other embodiments, or combined with or interchanged with the features of other embodiments, as appropriate, without departing from the scope of the present invention.

The present invention in a preferred form provides the advantages of an adaptable coupling able to accommodate tubular members of various diameters.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A coupling for connecting a hose to a pipe or a second hose, said coupling comprising:
a body having a first end, a second end, an exterior surface, an interior surface and a length from said first end to said second end, said interior surface forming a passage through said body from said first end to said second end, said passage having an entrance at said first end and an exit at said second end, said ends each having a maximum outer diameter, said exterior surface of said body having a middle portion between said ends, said middle portion having an outer diameter less than the maximum outer diameter of at least one of said ends; and
a locking collar having a unitary, non-adjustable body with an inner diameter and an outer diameter, the inner diameter being less than the maximum outer diameter of said at least one of said ends so that as said locking collar is moved along the length toward said at least one of said ends, said locking collar contacts a portion of the hose to trap the hose between said locking collar and said exterior surface of said body, permitting the hose to be clamped between said body and said locking collar during the flow of a liquid through said passage into the hose.

2. The coupling of claim 1, wherein said locking collar is a ring.

3. The coupling of claim 1, wherein the inner diameter of said locking collar is less than the maximum outer diameter of both said first and second ends.

4. The coupling of claim 1, wherein said exterior surface of said body forms a ramp with an outer diameter that increases in a direction towards said exit.

5. The coupling of claim 4, wherein said locking collar has an interior surface that is ramped to substantially match the angle of said ramp of said exterior surface of said body.

6. The coupling of claim 4, wherein said exterior surface of said body includes a plurality of projections along said ramp.

7. The coupling of claim 1, wherein said passage has a length, said passage having a constant diameter along a majority of the length of said passage to said exit.

8. The coupling of claim 1, wherein the outer diameter of said locking collar is greater than the maximum outer diameter of at least one of said ends.

9. The coupling of claim 1, wherein said locking collar has a radial thickness of at least 1 cm.

10. The coupling of claim 1, in combination with the hose.

11. A coupling for connecting a hose to a pipe or a second hose, said coupling comprising:
a body having a first end, a second end, an exterior surface, an interior surface and a length from said first end to said second end, said interior surface forming a passage through said body from said first end to said second end, said passage having an entrance at said first end and an exit at said second end, said exterior surface forming a ramp with an outer diameter that increases in a direction towards said exit, said ramp having a maximum outer diameter, said exterior surface of said body having a middle portion between said ends, said middle portion having an outer diameter less than the maximum outer diameter of ramp; and
a locking collar having an inner diameter and an outer diameter, the inner diameter being less than the maximum outer diameter of said ramp so that as said locking collar is moved along the length from said middle portion toward said exit, said locking collar contacts a portion of the hose to trap the hose between said locking collar and said ramp, permitting the hose to be clamped between said body and said locking collar during the flow of a liquid through said passage into the hose.

12. The coupling of claim 11, wherein said locking collar is a ring.

13. The coupling of claim 11, wherein said locking collar has an interior surface that is ramped to substantially match the angle of said ramp of said exterior surface of said body.

14. The coupling of claim 11, wherein said exterior surface of said body includes a plurality of projections along said ramp.

15. The coupling of claim 11, wherein said first end has a maximum outer diameter, the inner diameter of said locking collar being less than the maximum outer diameter of both said first end and said ramp.

16. The coupling of claim 11, wherein the outer diameter of said locking collar is greater than the maximum outer diameter of said ramp.

17. A method for connecting a first tubular member to a second tubular member, the method comprising:
connecting the first tubular member to a coupling having a first end, a second end, a length from the first end to the second end, and a passage from the first end to the second end, the first tubular member being connected to the first end;
engaging the second tubular member to the second end;
moving a locking collar along the length of the coupling until the locking collar traps the second tubular member at least in part between the locking collar and the coupling; and
clamping the second tubular member at least in part between the coupling and the locking collar using a flow of a liquid through the passage into the second tubular member.

18. The method of claim 17, wherein the second end of the coupling forms a nipple, the nipple being inserted into the second tubular member, the locking collar being moved along an exterior of the coupling towards the nipple to trap the second tubular member between the locking collar and the nipple.

19. The method of claim 17, further comprising applying a blunt force to the locking collar to move the locking collar along the length of the coupling to disengage the hose.

20. The method of claim 17, wherein the second tubular member is a flexible hose having an inner diameter different than that of the first tubular member.
